(19) United States
(12) Patent Application Publication
(10) Pub. No.: US 2007/0285632 A1
(43) Pub. Date: Dec. 13, 2007

(54) EUVL reticle stage and reticle protection system and method

(75) Inventors: Alton H. Phillips, East Palo Alto, CA (US); Douglas C. Watson, Campbell, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Nikon Corporation

(21) Appl. No.: 11/450,766

(22) Filed: Jun. 8, 2006

(51) Int. Cl. G03B 27/52

(52) U.S. Cl. 355/30; 355/53

(57) ABSTRACT

Apparatuses for and methods of maximizing particle protection while enabling temporary concurrent illumination of a reticle with exposure radiation through an aperture and auto focus beams or while mounting a reticle to or removing a reticle from a reticle stage are disclosed.

### BACKGROUND

1. Technical Field

Embodiments disclosed herein relate to an apparatus for and method of protecting a reticle on a reticle stage in a lithography system, such as an extreme ultraviolet lithography (“EUVL”) system.

2. Related Art

Protection from particulate matter (i.e., dust, dirt, etc.) contaminating objects of interest is required in many fields of application, including applications in semiconductor manufacturing such as microlithography. As microprocessors become faster and more powerful, an ever increasing number of transistors are required to be positioned on a semiconductor chip. The increased transistor density necessitates closer placement of the transistors, smaller device sizes, and interconnects that take less space. To achieve such great circuit density, the exposure radiation wavelengths used in microlithography are decreasing from visible to VUV, EUV, and smaller in next generation lithography (“NGL”) tools.

In a microlithography exposure process, a reticle with a desired pattern on one side is illuminated by the radiation, and the radiation transfers an image of the pattern to the substrate to create a part of the desired circuit. Conventional reticles are typically for use with longer wavelength exposure radiation. As a result, a clear faceplate, called a pellicle, can be utilized to cover and protect the pattern side of a reticle from particulate matter that would obscure the pattern.

As the features grow smaller, resulting in the need for shorter wavelengths, e.g. EUV radiation, the pellicle can not be utilized as present materials absorb too much of the radiation for process efficiency and deteriorate quickly. Therefore, using other methods of protecting the pattern side of the reticle in a lithography system from contamination may be used. The structures and methods for particle protection must not interfere with the exposure of the reticle or any other required calibration procedures.

Referring to wafer processing equipment, FIG. 1 illustrates a portion of one type of lithographic exposure system 50. It should be noted that FIG. 1 is not to scale, nor are the components' sizes necessarily proportional. The depicted system is a projection-exposure system that performs step-and-scan lithographic exposures using light.

Reticle 52 can be mounted via a reticle chuck 56 on a reticle stage 58. Reticle stage 58 can be operable to hold and position reticle 52 in at least the X- and Y-axis directions as required for proper alignment of reticle 52 relative to the substrate 54 for accurate exposure. Reticle stage 58 may also be operable to rotate reticle 52 as required about the Z-axis. Reticle stage 58 can be moveably coupled to a supporting reticle stage frame or base 60, which can be coupled to a main supporting frame 62 of lithography system 50.

A projection-optical system 64 and substrate 54 can be disposed in the path of reflected patterned beam from reticle 52. Projection-optical system 64 can include several optical elements (not shown). Patterned beam reflecting from reticle 52, carrying an aerial image of the illuminated portion of reticle 52, can be “reduced” (demagnified) by a desired factor (e.g., ¼ or some other appropriate factor) by projection-optical system 64 and focused on a surface of substrate 54, thereby forming a latent image of the illuminated portion of the pattern on substrate 54. The top surface of substrate 54 can be coated with a suitable resist to form the image carried by the patterned beam. Projection-optical system 64 can be coupled to a supporting projection-optical system frame 66, which can be coupled in fixed relation via vibration isolators 69 to main supporting frame 62.

Substrate 54 may be mounted by an electrostatic or other appropriate mounting force via a substrate “chuck” (not shown but well understood in the art) to a substrate table 70 mounted to a substrate stage 72. Substrate stage 72 can be configured to move substrate table 70 (with attached substrate) in the X-direction, Y-direction, and theta Z (rotation about the Z axis) direction relative to the projection-optical system 64, in addition to the three vertical degrees of freedom. Desirably, substrate stage 72 can be mounted on and supported by vibration-attenuation devices 73 which are well understood in the art. Substrate stage 72 can be moveably coupled to a supporting substrate frame 61, which can be coupled to main supporting frame 62 of lithography system 50. The position of the substrate stage 72 is detected interferometrically, in a manner known in the art.

During a lithographic exposure performed using system 50 shown in FIG. 1, light is directed onto a selected region of a reflective surface 74 of reticle 52. As exposure progresses, reticle 52 and substrate 54 are scanned synchronously (by their respective stages 58, 72) relative to projection-optical system 64 at a specified velocity ratio determined by the demagnification ratio of projection-optical system 64. Normally, because not all of the pattern defined by reticle 52 can be transferred in one “shot,” successive portions of the pattern, as defined on reticle 52, are transferred to corresponding shot fields on substrate 54 in a step-and-scan manner. By way of example, a 25 mm×25 mm square chip can be exposed on substrate 54 with an IC pattern having a 0.07 μm line spacing at the resist on substrate 54.

When a particular reticle 52 is first mounted on a reticle stage 58 and, occasionally, at other times, its position on reticle stage 58 may need to be determined. Then the best position of substrate stage 72 relative to reticle 52 may need to be determined for the best focus and calculation of the actual magnification of the system at the best focus position of substrate stage 72. Both the best focus and magnification measurement procedures involve exposing a portion of reticle 52 to exposure light through an aperture (not shown) as previously discussed. Other sensors (not shown) used in conjunction with the interferometers (not shown) to detect the relative positions of reticle 52 and substrate 54 during the step and scan exposure project must be calibrated (in effect “zeroed”) in the best focus position to use their information accurately. Calibration may be accomplished through the use of auto-focus (“AF”) beams (not shown) that illuminate a portion of reticle 52. That portion is typically larger than the portion exposed during the step and scan process as previously described.

In some instances, use of a reticle in an EUV lithography system may involve simultaneous exposure to the EUV beam that requires the presence of an appropriate aperture frame over the reticle and to the auto-focus beams for calibrating associated positioning sensors that require no interference from structures between the auto-focus beam source and the portion of the reticle to be illuminated. Therefore, there is a need for a particle contamination protection system that maximizes protection but still allows full functionality of the reticle, including illuminating a portion with auto-focus beams.

### SUMMARY

As embodied and broadly described herein, embodiments consistent with the invention can include an EUV lithography tool having a particle contamination reduction element, a particle contamination reduction apparatus for an object, a method of maximizing particle contamination protection with a gas flow system, a lithography method, and a method of performing auto-focus on a reticle protected by a gas flow system.

An EUV lithography tool to project an image onto a substrate using EUV radiation according to some embodiments of the invention can include a reticle defining an image and a particle contamination reduction element position adjacent the reticle and configured to substantially reduce particles from contaminating the reticle. The particle contamination reduction element can include a planar shield provided a predetermined distance away from the reticle and one or more movable protrusions extending from the planar shield toward the reticle. The one or more movable protrusions form a variable-sized opening adjacent the reticle and vary the size of the opening when one or more of the movable protrusions moves.

A particle contamination reduction apparatus for an object according to some embodiments of the invention can include at least one object shield having a variable-sized opening therein, two or more gas ports coupled to the at least one object shield, and an aperture frame disposed in the variable-sized opening between at least two of the two or more gas ports.

The object shield can include a planar portion at a distance, d, away from the surface of an object to be protected from particle contamination, and one or more portions projecting from the planar portion toward the surface of the object to be protected from particle contamination and forming at least a part of the perimeter of a variable-sized opening in the object shield. The object shield covers the surface of the object to be protected from particle contamination except for a portion of the surface exposed by the variable-sized opening.

At least two or more gas ports are positioned adjacent the variable-sized opening and positioned between the planar portion and the surface of the object to be protected so as to emit gas flow parallel to the surface of the object to be protected from particle contamination and away from the perimeter of the variable-sized opening. At least one of the two or more gas ports may move with respect to the planar portion, thereby varying the size of the variable-sized opening.

A method of maximizing particle contamination protection with a gas flow system according to some embodiments consistent with the invention can include providing two or more gas ports, at least one of which is movable, wherein at least two of the two or more gas ports emit gas parallel to a face of an object to be protected from particle contamination, providing an aperture frame positioned between at least two of the two or more gas ports, positioning at least one of the at least one movable gas ports close to the aperture frame to maximize protection of the object from particle contamination and moving at least one of the gas ports of the two or more gas ports apart from the aperture frame when necessary to enlarge the space between them to permit a predetermined process to be performed on the object.

A lithography method according to some embodiments consistent with the invention can include illuminating a reticle with auto focus beams to calibrate interferometer sensors and moving at least two gas ports closer together after illuminating a reticle with auto focus beams.

A method of performing auto-focus on a reticle protected by a gas flow system according to some embodiments consistent with the invention can include moving gas ports apart to enlarge a space formed between them, directing auto focus beams through the space between the gas ports, wherein the auto focus beams illuminate a reticle without interference from an aperture frame disposed in the space between the gas ports.

A method of mounting a reticle on or removing a reticle from a reticle stage while maintaining thermophoretic gas pressure around the reticle according to some embodiments of the invention can include horizontally moving a reticle transport device toward the reticle stage in a space between a stationary reticle shield and a plane containing a patterned surface of the reticle when mounted on the reticle stage to a first reticle transport position, horizontally moving the reticle stage to a first stage position wherein the reticle can be mounted on or released from the reticle stage, vertically moving the reticle transport device to a second reticle transport position, wherein the reticle can be mounted on or released from the reticle stage, vertically moving the reticle transport device from the second reticle transport position to the first reticle transport position, and horizontally moving the reticle transport device away from the reticle stage.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with some embodiments of the invention and together with the description, serve to explain the principles of the invention. In the drawings,

FIG. 1 shows a side view of a lithography system with a reticle stage, metrology frame, a projection-optical system, and a substrate stage;

FIG. 2 shows a side view of a “chucked” reticle and reticle shields according to some embodiments of the invention, showing an end effector with thickness “t” having space to move between the right reticle shield and the reticle;

FIG. 3 shows a side view of the chucked reticle and reticle shields shown in FIG. 2, but the reticle chuck has translated to the right and the end effector has translated up such that it is directly below the reticle;

FIG. 4 shows a side view of the chucked reticle and reticle shields shown in FIGS. 1 and 2, with a “skirt” according to some embodiments of the invention close to the reticle shields when the reticle chuck is translated to the right;

FIG. 5 shows a cross-sectional view of a reticle with a gas flow protection system according to some embodiments of the invention in an EUV beam scanning position;

FIG. 6 shows a top view of a gas flow protection system according to some embodiments of the invention and an aperture frame in an EUV beam scanning position;

FIG. 7 shows a top view of the gas flow protection system shown in FIG. 6 in an AF calibration position;

FIG. 8 shows an X-Z cross-sectional view of a microlithographic system according to some embodiments of the invention;

FIG. 9 shows a Y-Z cross-sectional view of the microlithographic system shown in FIG. 8;

FIG. 10 shows a lithography system according to some embodiments of the invention;

FIG. 11 a diagram of a process of fabricating semiconductor devices;

FIG. 12 is a detailed flow diagram of step 1004 of the process shown in FIG. 11.

### DETAILED DESCRIPTION

Reference will now be made in detail to exemplary embodiments consistent with the invention, which are illustrated in the accompanying drawings. Wherever possible, the same reference numbers will be used throughout the drawings to refer to the same or like parts.

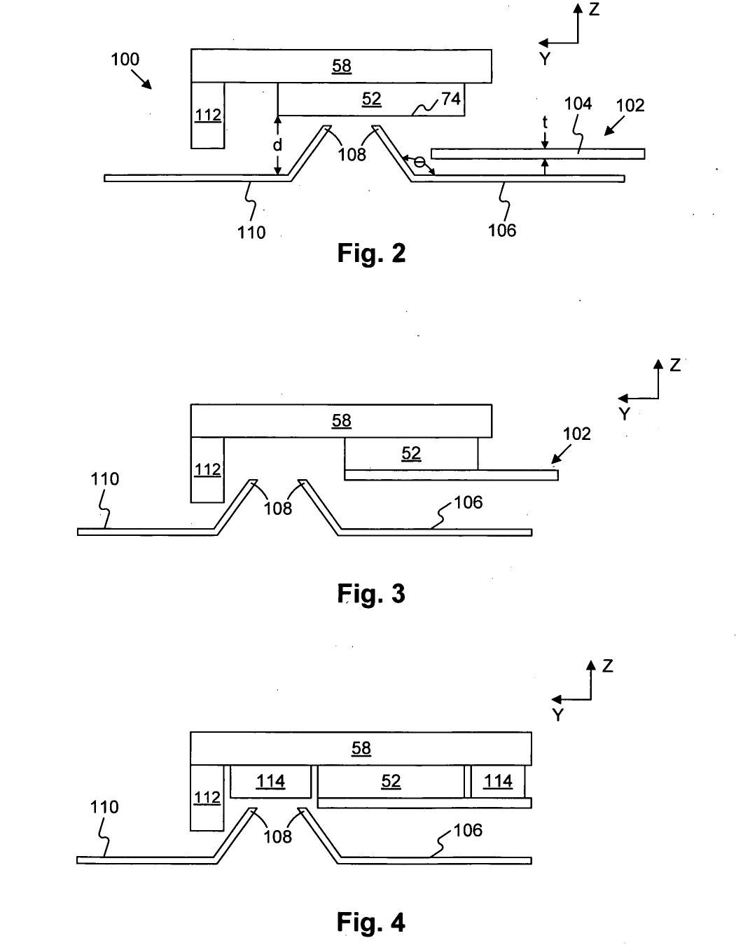

FIG. 2 illustrates reticle shields according to some embodiments of the invention. A reticle 52 is illustrated mounted to reticle stage 58. An end effector 102 having a thickness “t” is illustrated in the space between reticle shield 106 and reticle 52. In some embodiments, reticle shield 106, on the right, has a portion 108 projecting from the horizontal, planar portion of reticle shield 106 toward patterned side 74 of reticle 52 and forming a vertical gap between portion 108 and patterned side 74 of about 1 mm. In some embodiments, reticle shield 110, on the left, also has a portion 108 projecting from a horizontal, planar portion of reticle shield 110 toward patterned side 74 of reticle 52 and forming a vertical gap between portion 108 and patterned side 74 of about 1 mm. The perimeter of the horizontal opening defined in part by edge portions 108 may function as an aperture for irradiating radiation. The vertical gap defined in part by edge portions 108 and reticle 52 may function as a low conductance seal for gases present near reticle 52 and reticle chuck 56, maintaining a pressure differential and preventing any significant volumetric flow of gas and/or particles from migrating. If there is no vertical gap, portion 108 contacts patterned side 74 of reticle 52, which may be undesirable due to possible damage to patterned side 74. A pressure differential of 45 mtorr (50 mtorr in the space around the reticle, also referred to as the reticle stage area, and 5 mtorr in photo-optics chamber 64) may be maintained with vertical gaps up to about 2 mm. Other pressure differentials can be maintained depending on sizing of the vertical gap.

In some embodiments, reticle shields 106 and 110 may be configured as shown in FIG. 2, with a horizontal, planar portion of the reticle shield a distance “d” from reticle 52, where “d” is greater than 1 mm. In some embodiments, “d” may be from about 10 mm to about 15 mm. In some embodiments, like the one illustrated in FIG. 2, “d” may accommodate an end effector 102 of thickness “t”.

Thermophoretic particle protection, in some embodiments, relies on the reticle chamber pressure and a temperature gradient calculated as ΔT/d, where ΔT is the difference between the average temperature of patterned surface of reticle 52 and the average temperature of reticle shields 106 and 110. For a given temperature difference, as reticle chamber pressure decreases, “d” must increase to maintain effective thermophoretic particle protection. For a given reticle chamber pressure, if d is increased, then ΔT should be increased to maintain the same gradient. In some embodiments, where thermophoretic particle protection is intended for reticle 52, “d” may be at least 110 mm, given a reticle chamber pressure of 50 mtorr. If different reticle chamber pressures are used, the minimum “d” may vary accordingly.

The angle theta, θ, formed between the planar portion of reticle shield that is a distance “d” away from reticle 52 and the projecting edge portion 108 in FIG. 2 is approximately 120 degrees. When edge portions 108 are intended to provide an aperture, an angle between 90 and 180 degrees may be desirable, depending on the intended angle of incidence on patterned side 74 of reticle 52. In some embodiments, a mirror 112 for use in measuring the location of reticle stage 58 along the Y axis may be attached to reticle stage 58. Reticle shields must not mechanically interfere with mirror 112, and thus “d” may be sized, in those embodiments, to be greater than the distance mirror 112 extends downward from reticle stage 58. Moreover, the angled portion of reticle shield 110, in those embodiments, must also not mechanically interfere with mirror 112. Other design configurations may be envisioned by one skilled in the art.

FIG. 3 illustrates how end effector 102 gains access to reticle 52 in order to support it when it is released from reticle chuck 56. A reticle transport device, such as end effector 102 moves horizontally in the space between a plane containing the bottom surface of reticle 102 and a plane containing the top surface of the planar portion of reticle shielding plate 106. Reticle stage 58 translates, for example, via linear bearings and actuator (not shown) to the right to position reticle 52 directly in line with end effector 102. End effector 102 moves vertically to position itself under reticle 52. Once in the position illustrated in FIG. 3, reticle 52 may be released from reticle stage 58 and then be supported by end effector 102. End effector 102 with supported reticle 52 may then lower and remove reticle 52 from the reticle stage area. A similar process, but in reverse, may be used to transport reticle 52 on an end effector 102 for mounting on reticle stage 104.

In some embodiments, like the one illustrated in FIG. 3, the low conductance seal formed between edge portions 108 and reticle 52 disappears once reticle 52 is translated past an edge portion 108. Thus, in FIG. 3, gases containing contaminants may flow from the reticle stage area, which may be higher pressure, in some embodiments, than the surrounding environment within the microlithography system.

FIG. 4 illustrates a solution according to some embodiments of the invention to preserve the low conductance seal when reticle 52 is translated past an edge portion 108. In some embodiments, a member 114 may be disposed in any location next to reticle 52 that may be above an edge portion 108 of reticle shield 106 or 110. When member 114 surrounds reticle 52, it may be called a “skirt.” “Skirt” may be used herein to refer to member 114, but does not necessarily mean that it must completely encompass the perimeter of reticle 52. It should be noted that the space, or gap, between reticle 52 and member 114 should be small to preserve the low conductance seal. The gap in FIG. 3 is not drawn to scale, but is enlarged to demonstrate that it may exist to improve the ease with which reticle 52 may be positioned with end effector 102 and still maintain the low conductance seal.

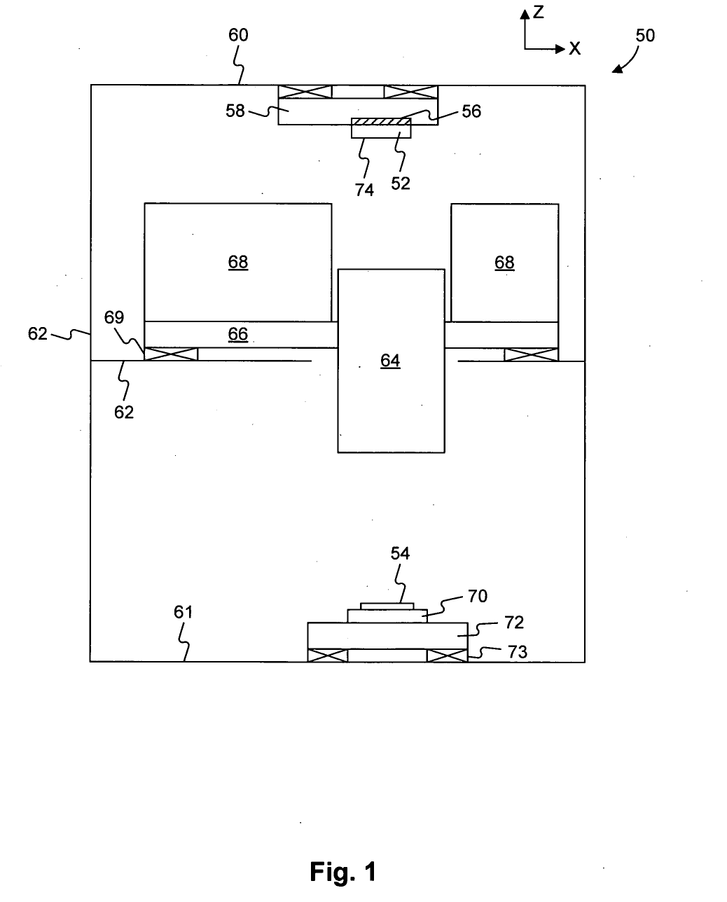

Another aspect of the invention that may be used in combination with the aspects of the invention described in conjunction with FIGS. 1-4, is to provide an aperture frame separate from reticle shields and to blow gas parallel to the patterned side 74 of reticle 52 from gas ports positioned on the reticle shields.

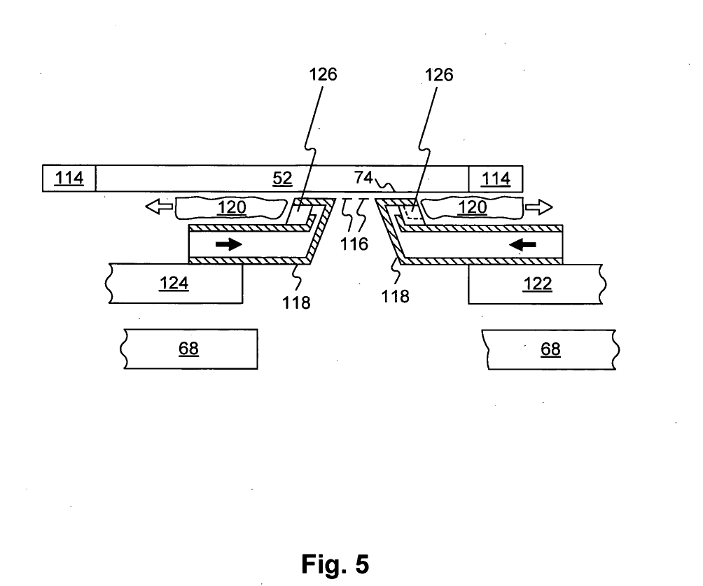

FIG. 5 illustrates a reticle 52 mounted via reticle chuck 56 (not shown) to reticle stage 58 (not shown) and surrounded by a skirt 114. As illustrated in FIG. 5, in some embodiments, an aperture frame 116 may be positioned below reticle 52 for use as an aperture with EUV or other radiation. In some embodiments, aperture frame 116 is attached to supporting metrology frame 68 with a mounting bracket (not shown). As a result, in some embodiments, aperture frame 116 can be fixed relative to supporting metrology frame 68. In some embodiments, aperture frame 116 can be fixed relative to reticle stage base 60. In some embodiments, aperture frame 116 can be fixed relative to both metrology frame 68 and reticle stage base 60 (not shown). On the right side of aperture frame 116, in FIG. 5, is a right-facing gas port 118, which emits a flow of gas 120 to the right past part of reticle 52 and skirt 114. In some embodiments, right-facing gas port 118 is attached to a reticle shield 122. In some embodiments, an upper face of gas port 118, if positioned close enough to reticle 52, e.g., about 1 mm away, may provide at least a part of a low conductance seal as described above.

On the left side of aperture frame 116, in FIG. 5, is a left-facing gas port 118, which emits a flow of gas 120 to the left past part of reticle 52 and skirt 114. In some embodiments, an upper face of left-facing gas port 118 can be positioned close enough to reticle 52 to form a low conductance seal as described above. Left-facing gas port 118 may be mounted to a reticle shield 124.

Gas may exit left-facing and right-facing gas ports 118 through small orifices or a section of porous material 126. In FIG. 5, left-facing and right-facing gas ports 118 are shown providing a gas supplying pathway or manifold connected to porous material 126. Examples of porous materials for use in gas ports 118 include a polycarbonate membrane filter, available from Structure Probe, Inc., an electrostatically charged polypropylene fibrous filter, available from 3M, or a porous nickel metal filter, available from Mott Corporation. Any filter material will work which functions to remove harmful particles from the gas flow and prevents them from migrating to the reticle.

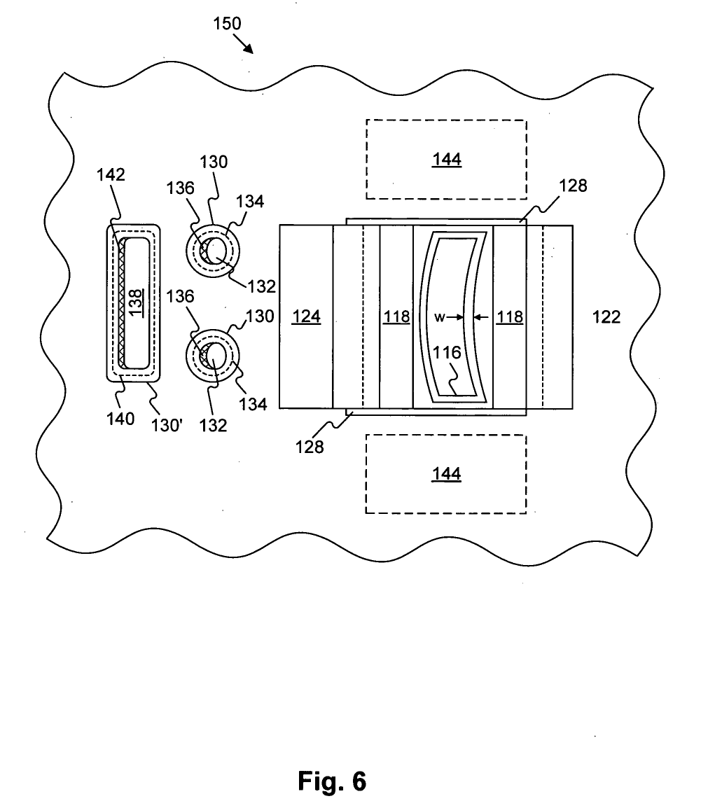

In FIG. 6, a top view of system 150 (looking down from reticle 52), aperture frame 116 may be disposed in a variable-sized opening (“window”), the perimeter of which may be formed by left-facing and right-facing gas ports 118 and low conductance seal-providing-structures 128. In some embodiments, aperture frame 116 can be of a constant width “w.” In some embodiments, w may be of varying dimension. In some embodiments, w can be about 2 mm. A narrower, as well as a wider, aperture frame can be used. An aperture frame of a different configuration may also be used. However, the narrower aperture frame 116 is, the better for gas flow particle contamination protection for patterned surface 74 of reticle 52, as it will permit closer positioning of gas ports 118, thereby increasing the amount of patterned surface 74 protected by gas flow 120 (see FIG. 5) emitted from gas ports 118.

Gas ports 118, in some embodiments, extend the entire width of reticle 52 (not shown). Positioning of gas ports 118 may be fixed, as when a gas port is attached to fixed reticle shield 122, or moveable, as when a gas port is attached to a retractable reticle shield 124.

Structures 128 function like the projecting edge portion 108 of reticle shields 106 and 110, as described in FIGS. 2-4, to form low conductance seals to prevent significant volumetric flows of gas in either direction and maintain different pressures on either side of the seal. When a gas port 118 is attached to a retractable reticle shield 124, structure 128 may extend the expected distance of travel of retractable reticle shield, if keeping a low conductance seal around the “window” is important. In some embodiments, structures 128 may contain a gas port that emits gas to flush or purge any contaminants from outgassing parts present near reticle 52 and or reticle stage 58 from passing to the space external to the reticle stage where it could possibly enter the projection-optics chamber 64 (see FIG. 1) and contaminate the optical elements within.

FIG. 6 also illustrates ring seals 130 that, in some embodiments, may surround a portion of microscope 132 that may protrude through a hole 134 in fixed reticle shield 122. Microscope 132 may be mounted on metrology frame 68, but needs to be close to, and maintain a line of vision to, the plane containing patterned side 74 of reticle 52 for its inspection. In some embodiments, ring seals 130 may be shaped like a flat washer. Ring seal 130 may have an outer diameter sized to be larger than through-hole 134 it covers, in excess of the designed relative motion between reticle shield 122 and microscope 132. Ring seal 130 may have an inner diameter sized just slightly larger than the diameter of microscope 132. Thus, the gap 136 between ring seal 130 and microscope 132 may be designed to be very small and function as a low conductance seal around microscope 132. In the same way, any gap between ring seal 130 and reticle shield 122 also may function as a low conductance seal. In some embodiments, a ring seal 130′ may surround an interferometer reference mirror 138 that may protrude through through-hole 140. Like ring seal 130, ring seal 130′ is dimensioned to provide a low conductance seal around interferometer reference mirror 138, due to the small size of any gap 142. Lastly, FIG. 6 illustrates, by dotted line rectangles, auto focus optics 144 that may be mounted to metrology frame 68 (see FIGS. 1-2) below fixed reticle shield 122.

During normal step and scan lithography process, gas ports 118 can be positioned close to aperture frame 116 to reduce the space between aperture frame 116 and gas ports 118. Positioning gas ports 118 close to aperture frame 116, such as in FIG. 6, permits maximum protection of patterned side 74 of reticle 52 from contamination by particles that may enter the flow of gas. Gas flow 120 (see FIG. 5) also forms a gas purge to flush/dilute molecular contaminants that may be present in the reticle stage area. Gas flow 120 may purge the volume near low conductance seals to prevent or at least minimize migration of molecular contaminants to projection-optics chamber 64 (see FIG. 1).

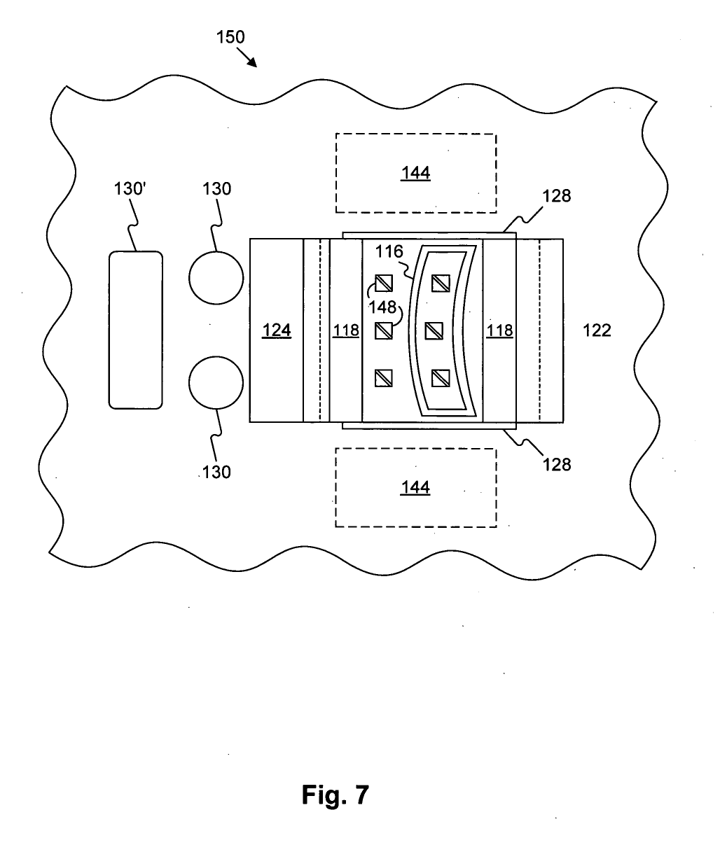

FIG. 7, like FIG. 6, illustrates a top view of system 150 except that retractable reticle shield 124 and attached left-facing gas port 118 is in its fully retracted position to enlarge the “window” formed between at least left-facing and right-facing gas ports 118. Such an enlarged window provides room for auto-focus beams to form an array of points on reflective surface 74 of reticle 52. The square areas 148 represent an example of areas through which the auto-focus beams may pass on their way to and from patterned side 74. In some embodiments, the auto focus area on patterned side 74 of reticle 52 is 110 mm×20 mm. In some embodiments, the angle of incidence is approximately 5 degrees from the patterned side 74 of reticle 52. In some embodiments, the AF beam comprises approximately 50 beam points. In some embodiments, an AF beam point is shaped like a 1.4 mm line angled at 45 degrees from the scanning axis, as illustrated by the diagonal lines in square areas 148. The beams are typically arranged in a grid pattern with uniform spacing along the x and y axes. One possible arrangement is a 5×10 beam point layout. Other arrangements will be apparent to one skilled in the art.

As described above, structure 128 extends at least as far as the expected travel of retractable reticle shield 124. Some embodiments of a reticle particle protection system will provide improved particle contamination protection, while enabling auto focus beams to illuminate patterned surface 74 of reticle 52 between gas ports 118 and aperture frame 116.

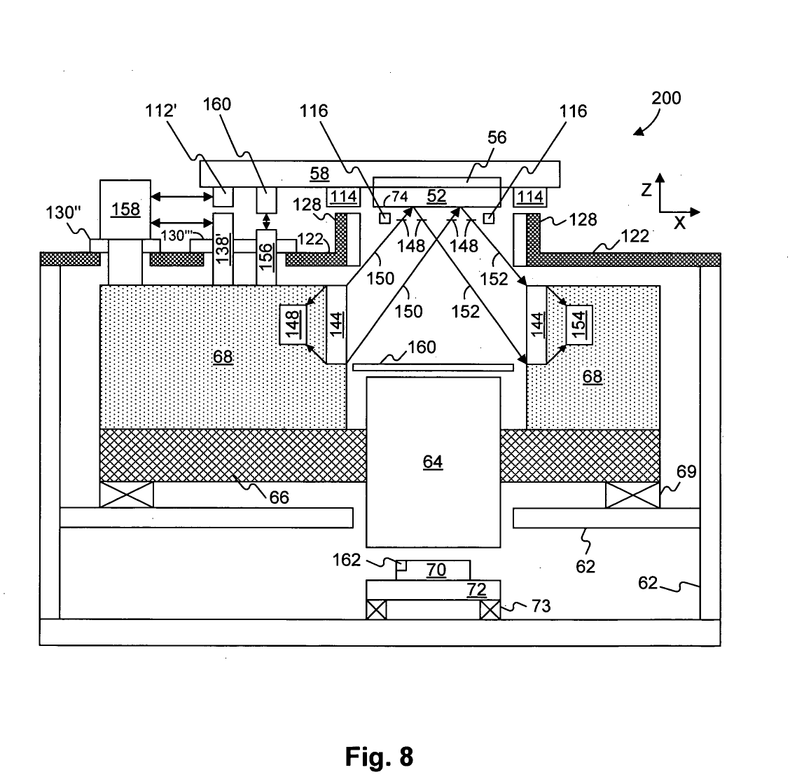

FIG. 8 illustrates a cross-sectional view in the X-Z plane of a microlithography system according to some embodiments of the invention. In this figure, reticle 52 is mounted via reticle chuck 56 to reticle stage 58. Reticle stage 58 may be movably coupled to main supporting frame 62 either directly or indirectly through reticle stage base 60 (not shown) as discussed in conjunction with FIG. 1. As illustrated in FIG. 8, reticle 52 may be surrounded by a skirt 114, and an aperture frame 116 may be disposed closely below patterned side 74 of reticle 52. For example, aperture frame 116 may be about 1 mm below patterned side 74 of reticle 52. The closer aperture frame 116 is to patterned side 74, the sharper, or, stated another way, the less blurred, the edges of the image reflected will be. In some embodiments, structure 128 may be positioned with an upper face close to skirt 114 to form a low conductance seal therebetween.

Metrology frame 68 may contain several components used in interferometric measurements or other inspections of reticle 52. For example, auto-focus beam emitter (light source) 148 projects beams to auto-focus optics 144, which in turn projects beams 150 onto patterned side 74 of reticle 52 without interference from aperture frame 116. Horizontal lines 148 are a side view of the areas through which incident beams 150 and reflected beams 152 pass. Reflected beams 152 may be collected by auto-focus optics 144 and passed to auto-focus beam receiver or detector 154.

Other components mounted on metrology frame 68 include “Z” distance interferometer 156, a reference mirror 138′, and X distance interferometer 158. In FIG. 8, double-headed arrows show light path between an interferometer and a respective reference mirror. In FIG. 8, these components protrude through through-holes in fixed reticle shield 122 and have low conductance ring seals 130 and 130′″ around the through-holes in reticle shield 122.

Reticle stage 58 may also have components for interferometric measurement mounted thereon. In some embodiments, such components include mirror 160 for use with Z interferometer 156 and mirror 112′ for use with X interferometer 158. In some embodiments, a fiducial glass 164 with a reticle fiducial mark (R-FM) thereon may be mounted on reticle stage 58. In some embodiments, skirt 114 and fiducial glass 164 may be one part.

Reticle alignment marks are typically used as reference marks in positioning reticle 52 in the X, Y, and theta-Z degrees of freedom. Reticle alignment marks present on each reticle 52 are illuminated with visible light and then measured by alignment microscopes 132. The measured positions of reticle alignment marks may then be used to align reticle 52 as desired with respect to photo-optics chamber 64.

With reticle 52 aligned, in some embodiments, an aerial imaging sensor (AIS) 162 disposed on substrate stage table 70 may then be used for determining a best focus position and the actual magnification of the projected pattern in that position. AIS measurement marks (not shown) on reticle 52 are used in a “best focus” measurement and a magnification measurement. A “best focus” measurement includes irradiating AIS measurement marks with exposure light that passes through aperture frame 116 and sensing the resulting projected image with AIS 162 on substrate stage table 70. A controller (not shown) steps substrate stage table 70 up and down. At each step, the contrast in the projected image is measured and compared to the previous step's contrast(s). The step with the greatest contrast is the best focus of the projection lens (not shown) located in projection-optics chamber 64.

In some embodiments, a magnification calibration may subsequently be performed. Exposure light (EUV) irradiates AIS measurement marks with wafer table 70 in the best focus position. The coordinates of the projected images of the at least two AIS measurement marks are then measured. A controller (not shown) compares the measured distance in the X direction between the projected image of the AIS measurement marks with the designed value. Any disparity is used by the controller to calculate a magnification error from the designed magnification.

After reticle 52 and substrate stage table 70 are in the relative positions that create the best focus of the projected pattern, the values of relative position sensors (interferometers) and auto-focus receiver or detector 154 are measured to create a baseline, thereby in effect zeroing the sensors. After the baseline is established, the auto focus system is then used to scan and map the topography of reticle patterned surface 74.

It may be desirable to add an additional method of particle protection to such a microlithographic system according to some embodiments of the invention, as depicted in FIG. 8. In such embodiments, an electro-magneto phoresis apparatus 160 may be disposed between reticle shield 122 and PO chamber 64. In some embodiments, electro-magneto phoresis apparatus 160 does not interfere with auto-focus incident beams 150 or reflected beams 152. Details regarding electro-magneto phoresis units and methods of particle protection may be found in U.S. Pat. Appl'n Publication No. U.S. 2002/0096647 A1, which is herein explicitly incorporated by reference.

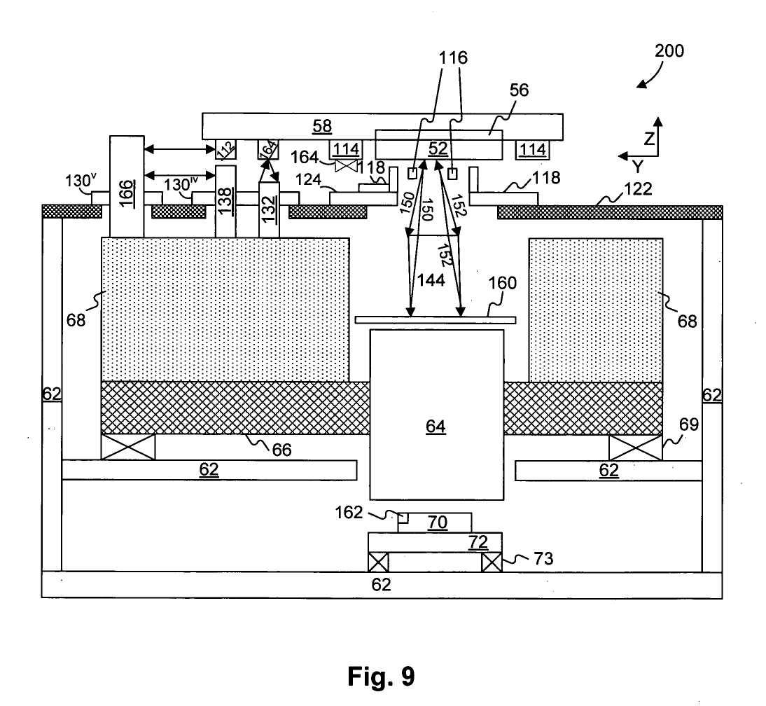

FIG. 9 illustrates the embodiment of system 200 shown in FIG. 8 in a cross section in the Y-Z plane. In FIG. 9, alignment microscope 132 and reference mirror 138, as described in FIG. 6, are depicted, as is a ring seal 130^{IV} providing a low conductance seal around microscope 132 and reference mirror 138. Y distance interferometer 166 may also be mounted on metrology frame 68. A double headed arrow illustrating the light path between interferometer 166 and reference mirrors 138 and 112 is shown. In some embodiments, the function of 164 and 114 may be achieved by a single part.

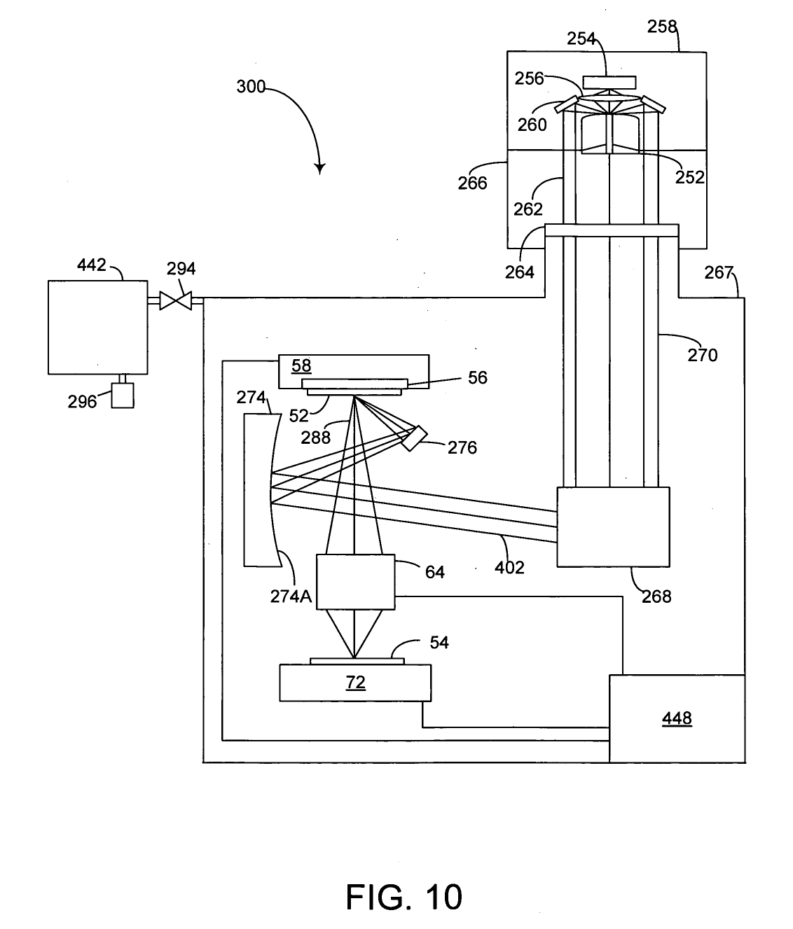

Referring to wafer processing equipment, FIG. 10 illustrates one example of an EUV (or soft-X-ray “SXR”) lithographic exposure system 150. The depicted system is a projection-exposure system that performs step-and-scan lithographic exposures using light in the extreme ultraviolet (“soft X-ray”) band, typically having a wavelength in the range of λ≈11-14 nm (nominally 13 nm). Lithographic exposure involves directing an EUV illumination beam to a pattern-defining reticle 52. The illumination beam 288 reflects from reticle 52 while acquiring an aerial image of the pattern portion defined in the illuminated portion of reticle 52. The resulting “patterned beam” is directed to an exposure-sensitive substrate 54, which upon exposure becomes imprinted with the pattern.

The EUV beam can be produced by a laser-plasma source 252 excited by a laser 254 situated at the most upper end of the depicted system 50. Laser 254 generates laser light at a wavelength within the range of near-infrared to visible. For example, laser 254 can be a YAG or an excimer laser, but other lasers can be used. Laser light emitted from laser 254 is condensed by a condensing optical system 256 and directed to downstream laser-plasma source 252.

A nozzle (not shown), disposed in laser-plasma light source 252, discharges xenon gas. As the xenon gas is discharged from the nozzle in laser-plasma light source 252, the gas is irradiated by the high-intensity laser light from the condensing optical system 256. The resulting intense irradiation of the xenon gas causes sufficient heating of the gas to generate a plasma. Subsequent return of Xe molecules to a low-energy state results in the emission of SXR (EUV) radiation with good efficiency having a wavelength of approximately 13 nm.

Since EUV light has low transmissivity in air, its propagation path preferably is enclosed in a vacuum environment produced in a vacuum chamber 258. Also, since debris tends to be produced in the environment of the nozzle from which the xenon gas is discharged, vacuum chamber 258 desirably is separate from other chambers of system 300.

A paraboloid mirror 260, provided with, for example, a surficial multi-layer Mo/Si coating, is disposed relative to laser-plasma source 252 so as to receive EUV light radiating from laser plasma source 252 and to reflect the EUV light in a downstream direction as a collimated beam 262. The multi-layer film on parabolic mirror 260 is configured to have high reflectivity for EUV light of which λ=approximately 13 nm.

Collimated beam 262 passes through a visible-light-blocking filter 264 situated downstream of the parabolic mirror 260. By way of example, filter 264 can be made of beryllium (Be), with a thickness of about 0.15 nm. Of the EUV radiation 262 reflected by parabolic mirror 260, only the desired 13 nm wavelength of radiation passes through filter 264. Filter 264 is contained in a vacuum chamber 266 evacuated to high vacuum.

An exposure chamber 267 can be situated downstream of pass filter 264. Exposure chamber 267 contains an illumination-optical system 268 that comprises at least a condenser-type mirror and a fly-eye-type mirror (not shown, but well understood in the art). Illumination-optical system 268 also is configured to shape EUV beam 270 (propagating from filter 264) to have an arc-shaped transverse profile. Shaped “illumination beam” 272 is irradiated toward the left in FIG. 10 and is received by mirror 274.

Mirror 274 has a circular, concave reflective surface 274A, and is held in a vertical orientation (in the figure) by holding members (not shown). Mirror 274 can be formed from a substrate made, e.g., of quartz or low-thermal-expansion material such as Zerodur (Schott). Reflective surface 274A is shaped with extremely high accuracy and coated with a Mo/Si multi-layer film that is highly reflective to EUV light. Whenever EUV light having a wavelength in the range of 10 to 15 nm is used, the multi-layer film on surface 274A can include a material such as ruthenium (Ru) or rhodium (Rh). Other candidate materials are silicon, beryllium (Be), and carbon tetraboride (B₄C).

A bending mirror 276 may be disposed at an angle relative to mirror 274, and is shown to the right of mirror 274 in FIG. 10. Reflective reticle 52, that defines a pattern to be transferred lithographically to the substrate 54, may be situated “above” bending mirror 276. Note that reticle 52 may be oriented horizontally with a reflective surface directed downward to avoid deposition of any debris on the patterned surface of reticle 52. Additional particle protection systems in accordance with the present invention may reduce the deposition of any debris on patterned surface 74 of reticle 52. Illumination beam 272 of EUV light emitted from illumination-optical system 268 may be reflected and focused by mirror 274, and reaches the reflective surface of reticle 52 via bending mirror 276.

As described previously, reticle 52 typically has an EUV-reflective surface configured as a multi-layer film. Pattern elements, corresponding to pattern elements to be transferred to the substrate (or “wafer”) 67, can be defined on or in the EUV-reflective surface. Reticle 52 can be mounted via a reticle chuck 56 on a reticle stage 58 that may be operable to hold and position reticle 52 in at least the X- and Y- axis directions as required for proper alignment of reticle 52 relative to the substrate 54 for accurate exposure. Reticle stage 58 can, in some embodiments, be operable to rotate reticle 52 as required about the Z-axis. The position of reticle stage 58 may be detected interferometrically in a manner known in the art. Hence, illumination beam 272 reflected by bending mirror 276 may be incident at a desired location on the reflective surface of reticle 52.

Again, as previously described, a projection-optical system 64 and substrate 54 can be disposed downstream of reticle 52. Projection-optical system 64 can include several EUV-reflective mirrors and apertures. Patterned beam 288 from reticle 52, carrying an aerial image of the illuminated portion of reticle 52, can be “reduced” (demagnified) by a desired factor (e.g., ¼) by projection-optical system 64 and may be focused on the surface of substrate 54, thereby forming an image of the illuminated portion of the pattern on substrate 54. So as to be imprintable with the image carried by patterned beam 288, the upstream-facing surface of the substrate 54 can be coated with a suitable resist.

Reticle 52 as mounted on reticle stage 58 may be separated by the various structures and gas flow as described with respect to FIGS. 2-8 from projection-optical system 64.

As previously described, substrate 54 may be mounted by an electrostatic or other appropriate mounting force via a substrate “chuck” (not shown but well understood in the art) to a substrate table 70 mounted to a substrate stage 72. Substrate stage 72 may be configured to move substrate table 70 (with attached substrate) in the X-direction, Y-direction, and theta Z (rotation about the Z axis) direction relative to projection-optical system 64, in addition to the three vertical degrees of freedom. Desirably, substrate stage 72 may be mounted on and supported by vibration-attenuation devices. The position of substrate stage 72 may be detected interferometrically, in a manner known in the art.

A pre-exhaust chamber 292 (load-lock chamber) may be connected to exposure chamber 267 by a gate valve 294. A vacuum pump 296 may be connected to pre-exhaust chamber 292 and serves to form a vacuum environment inside pre-exhaust chamber 92.

During a lithographic exposure performed using the system shown in FIG. 10, EUV light 272 may be directed by illumination-optical system 268 onto a selected region of the reflective surface of reticle 52. As exposure progresses, reticle 52 and substrate 54 are scanned synchronously (by their respective stages 58, 72) relative to projection-optical system 64 at a specified velocity ratio determined by the demagnification ratio of projection-optical system 64. Normally, because not all of the pattern defined by reticle 52 can be transferred in one “shot,” successive portions of the pattern, as defined on reticle 52, are transferred to corresponding shot fields on substrate 54 in a step-and-scan manner. By way of example, a 25 mm×25 mm square chip can be exposed on substrate 54 with an IC pattern having a 0.07 μm line spacing at the resist on substrate 54.

Coordinated and controlled operation of system 50 may be achieved using a controller (not shown) coupled to various components of system 50 such as illumination-optical system 268, reticle stage 58, projection-optical system 64, and substrate stage 72. For example, the controller operates to optimize the exposure dose on substrate 54 based on control data produced and routed to the controller from the various components to which the controller may be connected, including various sensors and detectors (not shown).

Many of the components and their interrelationships in this system are known in the art, and hence are not described in detail herein.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system may be adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment may be performed to make sure that every accuracy is maintained in the complete photolithography system. Additionally, it may be desirable to manufacture an exposure system in a clean room where the temperature and humidity are controlled.

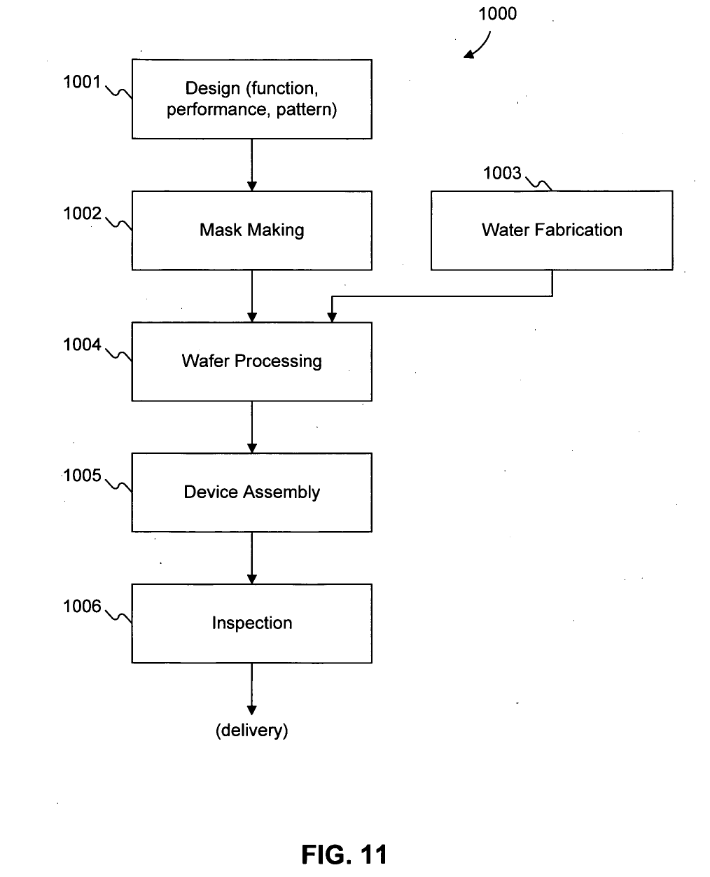

Further, semiconductor devices can be fabricated using the above described systems, by process 1000 shown generally in FIG. 11. In step 1001, the device's function and performance characteristics are designed. Next, in step 1002, a mask (reticle) having a pattern designed according to the previous designing step is made. In a parallel step 1003, a wafer is made from a silicon material. The mask pattern designed in step 1002 may be exposed onto the wafer from step 1003 in step 1004 by a photolithography system described hereinabove according to the principles of the present invention. In step 1005 the semiconductor device may be assembled (including the dicing process, bonding process and packaging process), then finally the device may be inspected in step 1006.

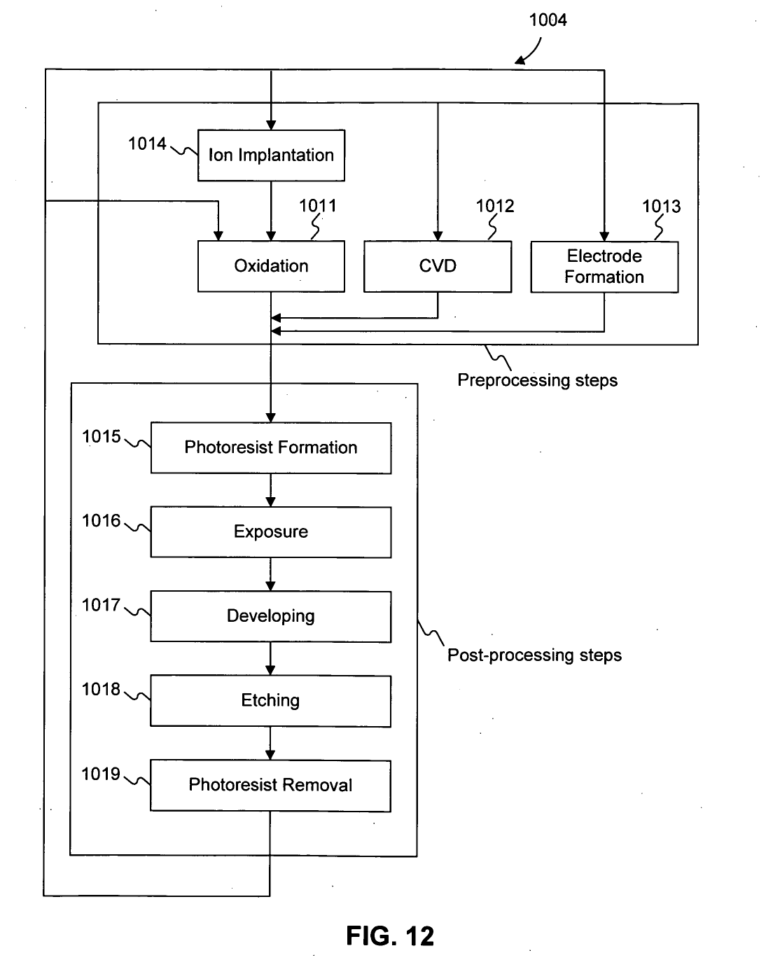

FIG. 12 illustrates a detailed flowchart example of the above-mentioned step 1004 in the case of fabricating semiconductor devices. In step 1011 (oxidation step), the wafer surface may be oxidized. In step 1012 (CVD step), an insulation film may be formed on the wafer surface. In step 1013 (electrode formation step), electrodes are formed on the wafer by vapor deposition. In step 1014 (ion implantation step), ions are implanted in the wafer. The above mentioned steps 1011-1014 form the preprocessing steps for wafers during wafer processing, and selection of specific steps and sequence of steps is done according to processing requirements.

At each stage of wafer processing, when the above-mentioned preprocessing steps have been completed, the following post-processing steps are implemented. During post-processing, initially, in step 1015 (photoresist formation step), photoresist is applied to a wafer. Next, in step 1016, (exposure step), the above-mentioned exposure device is used to transfer the circuit pattern of a mask (reticle) to a wafer. Then, in step 1017 (developing step), the exposed wafer is developed, and in step 1018 (etching step), parts other than residual photoresist (exposed material surface) are removed by etching. In step 1019 (photoresist removal step), unnecessary photoresist remaining after etching is removed.

Multiple circuit patterns are formed by repetition of these preprocessing and post-processing steps.

Other embodiments consistent with some embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An EUV lithography tool to project an image onto a substrate using EUV radiation, comprising:
a reticle defining an image; and
a particle contamination reduction element positioned adjacent the reticle and configured to substantially reduce particles from contaminating the reticle, the particle contamination reduction element comprising:
a planar shield provided a predetermined distance away from the reticle; and
one or more movable protrusions extending from the planar shield toward the reticle, the one or more movable protrusions forming a variable-sized opening adjacent the reticle, the size of the opening being varied by moving the one or more movable projections.

2. The tool of claim 1, further comprising an aperture frame disposed in the variable sized opening.

3. The tool of claim 2, wherein the aperture frame has a width dimension of about 2 mm.

4. The tool of claim 2, further comprising a metrology frame, and wherein the aperture frame is mounted to the metrology frame.

5. The tool of claim 4, further comprising:
auto focus optics coupled to the metrology frame and positioned to pass auto focus beams through the variable-sized opening without interference from the aperture frame.

6. The tool of claim 4, further comprising:
an electro-magneto phoresis unit coupled to the metrology frame.

7. The tool of claim 1, further comprising one or more gas ports positioned adjacent the variable sized opening and configured to create a gas flow away from the perimeter of the variable-sized opening to substantially reduce particles from contaminating the reticle.

8. The tool of claim 1, further comprising an aperture frame disposed in the variable-sized opening and one or more gas ports positioned adjacent the variable-sized opening and configured to create a gas flow substantially parallel and away from the reticle to substantially reduce particles from contamination the reticle,
wherein at least one of one or more gas ports is in a first position relative to the aperture frame during a first process and in a second position relative to the aperture frame during a second process.

9. The tool of claim 8, wherein the first process is a scanning step of a step and scan lithography process.

10. The tool of claim 8, wherein the second process is an auto-focus calibration step of a step and scan lithography process.

11. The tool of claim 8, wherein the first position defines a smaller opening in the object shield than the second position.

12. The tool of claim 1, wherein the predetermined distance, d, is at least about 10 mm.

13. The tool of claim 1, wherein the predetermined distance, d, is about 10 mm.

14. The tool of claim 1, wherein the predetermined distance, d, permits the vertical removal of the reticle.

15. The tool of claim 1, further comprising low conductance seals around components protruding through through-holes in the planar shield.

16. A particle contamination reduction apparatus for an object comprising:
at least one object shield comprising
a planar portion at a distance, d, away from a surface of an object to be protected from particle contamination; and
one or more portions projecting from the planar portion toward the surface of the object to be protected from particle contamination and forming at least a part of the perimeter of a variable-sized opening in the object shield,
wherein the object shield covers the surface of the object to be protected from particle contamination except for a portion of the surface exposed by the variable-sized opening;
two or more gas ports coupled to the at least one object shield, positioned adjacent the variable-sized opening and positioned between the planar portion and the surface of the object to be protected so as to emit gas flow parallel to the surface of the object to be protected from particle contamination and away from the perimeter of the variable-sized opening,
wherein at least one of the two or more gas ports may move with respect to the planar portion, thereby varying the size of the variable-sized opening; and
an aperture frame disposed in the variable-sized opening between at least two of the two or more gas ports.

17. The apparatus of claim 16, wherein at least two of the two or more gas ports may be moved, thereby varying the size of the variable-sized opening.

18. The apparatus of one of claims 16 and 17, wherein at least two of the two or more gas ports are in a first position relative to the aperture frame during a first process and in a second position relative to the aperture frame during a second process.

19. The apparatus of claim 18, wherein the first process is a scanning step of a step and scan lithography process.

20. The apparatus of claim 18, wherein the second process is an auto-focus calibration step of a step and scan lithography process.

21. The apparatus of claim 18, wherein the first position defines a smaller opening in the object shield than the second position.

22. The apparatus of claim 16, wherein the distance, d, is at least about 10 mm.

23. The apparatus of claim 16, wherein the distance, d, is about 10 mm.

24. The apparatus of claim 16, wherein the distance, d, permits the vertical removal of the object to be protected.

25. The apparatus of claim 16, wherein the aperture frame has a width dimension of about 2 mm.

26. The apparatus of claim 16, further comprising a metrology frame, and wherein the aperture frame is mounted to the metrology frame.

27. The apparatus of claim 26, further comprising:
auto focus optics coupled to the metrology frame and positioned to pass auto focus beams through the variable-sized opening without interference from the aperture frame.

28. The apparatus of claim 26, further comprising:
an electro-magneto phoresis unit coupled to the metrology frame.

29. The apparatus of claim 16, further comprising low conductance seals around components protruding through through-holes in the object shield.

30. A method of maximizing particle contamination protection with a gas flow system comprising:
providing two or more gas ports, at least one of which is movable, wherein at least two of the two or more gas ports emit gas parallel to a face of an object to be protected from particle contamination;
providing an aperture frame positioned between at least two of the two or more gas ports;
positioning at least one of the at least one movable gas ports close to the aperture frame to maximize protection of the object from particle contamination; and
moving at least one of the gas ports of the two or more gas ports apart from the aperture frame when necessary to enlarge the opening between the two or more gas ports to permit a predetermined process to be performed on the object.

31. The method of claim 30 wherein the predetermined process is directing auto focus beams through the space.

32. The method of claim 30, wherein the auto focus beams pass through the aperture frame and between the aperture frame and a first of two or more gas ports and between the aperture frame and a second of two or more gas ports.

33. A method of lithography comprising:
illuminating a reticle with auto focus beams to calibrate an auto-focus sensor; and
moving at least one of two or more gas ports closer together after illuminating a reticle with auto focus beams.

34. A method of performing auto-focus sensor calibration on a reticle protected by a gas flow system comprising:
moving at least a first gas port emitting gas parallel to a reticle apart from at least a second gas port to temporarily enlarge an opening between them;
directing auto focus beams through the opening between the first and second gas ports,
wherein the auto focus beams illuminate a reticle without interference from an aperture frame disposed in the opening between the first and second gas ports.

35. A method of mounting a reticle on or removing a reticle from a reticle stage while maintaining thermophoretic gas pressure around the reticle, the method comprising:
horizontally moving a reticle transport device toward the reticle stage in a space between a stationary reticle shield and a plane containing a patterned surface of the reticle when mounted on the reticle stage to a first reticle transport position;
horizontally moving the reticle stage to a first stage position wherein the reticle can be mounted on or released from the reticle stage;
vertically moving the reticle transport device to a second reticle transport position, wherein the reticle can be mounted on or released from the reticle stage;
vertically moving the reticle transport device from the second reticle transport position to the first reticle transport position; and
horizontally moving the reticle transport device away from the reticle stage.
